(19) United States
(12) Patent Application Publication
(10) Pub. No.: US 2024/0267178 A1
(43) Pub. Date: Aug. 8, 2024

(54) SYSTEM OF PRIORITIZATION FOR DOWNLINK VEHICLE COMMUNICATION

(71) Applicant: TOYOTA MOTOR ENGINEERING & MANUFACTURING NORTH AMERICA, INC., Plano, TX (US)

(72) Inventors: EMRAH AKIN SISBOT, Mountain View, CA (US); Yashar Zeiynali Farid, Mountain View, CA (US); Xiaofei Cao, Mountain View, CA (US); Haritha Muralidharan, Mountain View, CA (US); Kentaro Oguchi, Mountain View, CA (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-Shi (JP)

(21) Appl. No.: 18/163,833

(22) Filed: Feb. 2, 2023

(51) Int. Cl. H04L 5/00; H04W 72/1273; H04W 72/56

(52) U.S. Cl. CPC H04L 5/0048; H04W 72/1273; H04W 72/56

(57) ABSTRACT

Systems and methods are provided for prioritizing downlink vehicle communication. Such systems and methods leverage transit-impacting event category determinations, and transit-impacting event category-specific parameters to quickly (and efficiently) provide tailored downlink vehicle communication priority orders to requesting transit-related services.

### TECHNICAL FIELD

The present disclosure relates generally to automotive systems and technologies, and more particularly, some examples relate to systems for prioritizing downlink vehicle communication.

### DESCRIPTION OF RELATED ART

Today, many vehicles are connected to transit-related services (e.g., traffic jam-detection services, accident detection services, unsafe road condition detection services, vehicle navigation services, weather reporting services, vehicle software update services, etc.) that provide information to the connected vehicles via downlink communication. Some of these transit-related services are cloud-based.

As used herein, downlink vehicle communication (or more generally “downlink communication”) may refer to wireless communications which are transmitted “downwards” to vehicles from a higher level or portion of a network, such as the cloud.

### BRIEF SUMMARY OF THE DISCLOSURE

According to various examples of the disclosed technology, a method for determining a downlink communication priority order is provided. The method may comprise: (1) determining a transit-impacting event category for a transit-impacting event; (2) computing downlink communication priority scores for a plurality of vehicles using a set of parameters specific to the transit-impacting event category; (3) determining a downlink communication priority order for the plurality of vehicles according to the downlink communication priority scores; and (4) transmitting the downlink communication priority order to a transit-related service. In various examples, computing the downlink communication priority scores for the plurality of vehicles using the set of parameters specific to the transit-impacting event category may comprise applying, to the set of parameters specific to the transit-impacting event category, geographical locations of the plurality of vehicles and characteristics of the plurality of vehicles. In some examples, the method may further comprise applying a geographical location associated with the transit-impacting event to the set of parameters specific to the transit-impacting event category. In certain examples, the method may further comprise: (a) receiving, from the transit-related service, a request to provide the downlink communication priority order for transmitting downlink communications related to the transit-impacting event; and (b) determining a transit-related service category for the transit-related service. In these examples, the set of parameters specific to the transit-impacting event category may also be specific to the transit-related service category.

In various examples, a system for determining a downlink communication priority order is provided. The system may comprise: (1) one or more processing resources; and (2) a non-transitory computer-readable medium, coupled to the one or more processing resources, having stored therein instructions that when executed by the one or more processing resources cause the system to perform a method comprising: (a) determining a transit-impacting event category for a transit-impacting event; (b) computing downlink communication priority scores for a plurality of vehicles using a set of parameters specific to the transit-impacting event category; (c) determining a downlink communication priority order for the plurality of vehicles according to the downlink communication priority scores; and (d) transmitting, according to the downlink communication priority order, downlink communications related to the transit-impacting event to the plurality of vehicles. In various examples, the system may comprise a cloud-based system. In other examples, the system may be implemented in roadside infrastructure.

In some examples, a cloud-based system for determining a downlink communication priority order is provided. The cloud-based system may comprise: (1) one or more processing resources; and (2) a non-transitory computer-readable medium, coupled to the one or more processing resources, having stored therein instructions that when executed by the one or more processing resources cause the device to perform a method comprising: (a) determining a transit-impacting event category for a transit-impacting event; (b) computing downlink communication priority scores for a plurality of vehicles by applying geographic locations associated with the plurality of vehicles and characteristics associated with the plurality of vehicles to a set of parameters specific to the transit-impacting event category; (c) determining a downlink communication priority order for the plurality of vehicles according to the downlink communication priority scores; and (d) transmitting the downlink communication priority order to a transit-related service. In some examples, the method may further comprise: (i) receiving, from the transit-related service, a request to provide the downlink communication priority order for transmitting downlink communications related to the transit-impacting event; and (ii) determining a transit-related service category for the transit-related service. In these examples, the set of parameters specific to the transit-impacting event category may also be specific to the transit-related service category. In various examples, the set of parameters specific to the transit-impacting event category may also be specific to the transit-related service.

Other features and aspects of the disclosed technology will become apparent from the following detailed description, taken in conjunction with the accompanying drawings, which illustrate, by way of example, the features in accordance with examples of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various examples, is described in detail with reference to the following figures. The figures are provided for purposes of illustration only and merely depict examples.

FIG. 1 illustrates an example downlink communication prioritization system, in accordance with various examples of the present technology.

FIG. 2 illustrates another example downlink communication prioritization system, in accordance with various examples of the present technology.

FIG. 3 depicts an example transit-impacting event during which various examples of the present technology may be implemented.

FIG. 4 illustrates example operations that can be performed to determine a downlink communication priority order for a plurality of vehicles, in accordance with various examples of the present technology.

FIG. 5 illustrates further example operations that can be performed to determine a downlink communication priority order for a plurality of vehicles, in accordance with various examples of the present technology.

FIG. 6 is an example computing component that may be used to implement various features of examples described in the present disclosure.

The figures are not exhaustive and do not limit the present disclosure to the precise form disclosed.

### DETAILED DESCRIPTION

As described above, many vehicles today are connected to transit-related services (e.g., traffic jam-detection services, accident detection services, unsafe road condition detection services, vehicle navigation services, weather reporting services, vehicle software update services, etc.) that provide information to the connected vehicles via downlink communication. However, as the number of connected vehicles increases, such downlink vehicle communication can experience significant delays/latency. Such delays/latency can become problematic (and even reduce safety) where downlink communications relate to transit-impacting events (e.g., events that impact vehicular transit such as traffic jams, roadside accidents, unsafe road conditions, etc.) that can be more effectively avoided by timely action.

For example, an unsafe road condition detection service may detect an icy patch of roadway on a highly-trafficked bridge. The service may need/desire to alert over 5,000 vehicles in close proximity (e.g., within 2 miles) of the bridge. However, alerting over 5,000 vehicles can cause non-trivial delays for downlink communication. Such delays can reduce safety for vehicles which have less time to react to the detected ice patch on the bridge by e.g., slowing down, changing lanes, modifying navigation route, etc.

As examples of the presently disclosed technology are designed in appreciation of, the negative impacts of the delayed downlink communication may be reduced if a later-alerted vehicle is relatively better-positioned/better-equipped to account for the transit-impacting event than other vehicles (e.g., the vehicle is far enough away from the bridge that there is sufficient time to modify navigation route, the vehicle is traveling at a slow speed, the vehicle is an all-terrain vehicle capable of handling icy road conditions, the vehicle is equipped with safety features such as an anti-lock braking system and/or semi-autonomous/assisted driving features, etc.). By contrast, the negative impacts of delayed downlink communication may be increased if a later-alerted vehicle is relatively worse-positioned/worse-equipped to account for the transit-impacting event than other vehicles (e.g., the vehicle is on the icy bridge or very close to the icy bridge, the vehicle is traveling at a fast speed, the vehicle is a high occupancy vehicle such as a bus or truck, the vehicle is an older vehicle with relatively fewer anti-skid safety features, etc.). In other words, certain vehicles may require/benefit from more urgent alerts related to a transit-impacting than other vehicles.

Accordingly, there is a need for systems that can quickly and effectively ensure that connected vehicles requiring relatively more urgent alerts related to a transit-impacting event receive downlink communications related to the transit-impacting event with increased expediency.

Against this backdrop, the present technology provides systems and methods for sequentially prioritizing downlink vehicle communication. Such systems and methods leverage transit-impacting event category determinations, and transit-impacting event category-specific parameters to quickly (and efficiently) provide tailored downlink vehicle communication priority orders to requesting transit-related services. By sequentially prioritizing downlink communication for connected vehicles according to the level of urgency they require, the present technology can reduce delays/latency associated with attempting to (simultaneously) alert a larger group of connected vehicles to the transit-impacting event. That is, the present technology can reduce delays/latency for sequentially earlier downlink communications, by sending downlink communications to connected vehicles requiring relatively less urgent alerts sequentially after the earlier downlink communications.

For example, a system of the present technology (e.g., a cloud-based system) may receive, from a transit-related service, a request to provide a downlink communication priority order for transmitting downlink communications related to a transit-impacting event to a plurality of vehicles. Here, the transit-related service may be various types of services that provide information to vehicles using downlink communication (e.g., traffic jam-detection services, accident detection services, unsafe road condition detection services, vehicle navigation services, weather reporting services, etc.). The transit-impacting event may be various types of events that impact vehicle transit (e.g., traffic jams, accidents, unsafe road conditions, weather events, etc.).

Upon receiving the downlink communication priority order request, the system can determine a transit-impacting event category for the transit-impacting event. Such a determination may be based on characteristics of the transit-impacting event as well as characteristics (and/or identity) of the transit-related service making the request. As will be described in greater detail below, the system can tune a balance/trade-off between accuracy/granularity and computational efficiency/speed by tuning a level of granularity for transit-impacting event categories.

Upon determining the transit-impacting event category for the transit-impacting event, the system can use a set of parameters specific to the transit-impacting event category to compute downlink communication priority scores. As used herein, a downlink communication priority score may refer to a measurement assigned to a given vehicle that quantifies a level of urgency for transmitting downlink communication related to the transit-impacting event to the given vehicle. Computing a downlink communication priority for the given vehicle may involve applying, to the transit-impacting event category-specific parameters, geographical locations associated with the transit-impacting event and the given vehicle and specific characteristics of the transit-impacting event and/or the given vehicle. As alluded to above, and as will be described in greater detail below, the system can leverage the transit-impacting event category-specific parameters to compute tailored downlink communication priority scores. That is, instead of using a “one-size-fits-all” set of parameters for all types of transit-impacting events, the system can leverage transit-impacting event category-specific parameters to determine downlink communication priority orders for particular transit-impacting events with greater accuracy/granularity.

In certain examples, the set of parameters used to compute the downlink communication priority scores may also be specific to the transit-related service. In related examples, the system may determine a transit-related service category for the transit-related service, and the set of parameters used to compute the downlink communication priority scores may also be specific to the transit-related service category.

Upon computing the downlink communication priority scores for the plurality of vehicles, the system can transmit the determined downlink communication priority order to the transit-related service. In various examples, the transmitted/determined downlink communication priority order may comprise an ordered list of the plurality of vehicles. In certain examples, instead of transmitting the determined downlink communication priority order to the transit-related service, the system may (directly) transmit downlink communications related to the transit-impacting event to the plurality of vehicles according to the determined downlink communication priority order.

As alluded to above, examples can leverage transit-impacting event categories and transit-impacting event category-specific parameters to determine tailored downlink communication priority orders with increased efficiency/speed. That is, instead of using a “one-size-fits-all” set of parameters for all types of transit-impacting events, examples can leverage transit-impacting event category-specific parameters to determine downlink communication priority orders for particular transit-impacting events with greater accuracy/granularity. Conversely, instead of using unique/specific sets of parameters for each of the myriad transit-impacting events that may occur, examples can determine/classify similar transit-impacting events using a common transit-impacting event category. Accordingly, examples can determine downlink communication priority orders more efficiently/quickly by leveraging transit-impacting event category-specific parameters for the common (and more generic) transit-impacting event category. Moreover, systems of the present technology can tune the above-described balance/trade-off between accuracy/granularity and computational efficiency/speed by tuning a level of granularity for the transit-impacting event categories. In particular, increasing granularity for transit-impacting event categories (e.g., an unsafe road condition event category instead of a traffic safety-impacting event category, or an icy road condition event category instead of an unsafe road condition event category) may improve accuracy/granularity for downlink communication priority orders at a cost of reduced computational efficiency/speed. By contrast, decreasing granularity for transit-impacting event categories may improve computational efficiency/speed at a cost of improved accuracy/granularity. Either way, by leveraging transit-impacting event categories and transit-impacting event category-specific parameters, systems of the present technology can tune improving accuracy/granularity vs. improving computational efficiency/speed in a highly configurable manner.

As alluded to above, the present technology provides numerous advantages. For example, by providing systems and methods for prioritizing downlink vehicle communication, the present technology can: (1) improve traffic safety (by e.g., accurately determining which vehicles should be alerted first to a given traffic safety-impacting event such as an unsafe road condition); (2) increase driver and passenger comfort (by e.g., accurately determining which vehicles should be alerted first to a given traffic efficiency-impacting event such as traffic jam or road closure); (3) improve fuel efficiency (by e.g., accurately determining which vehicles should be alerted first to a given fuel efficiency-impacting event such as stop-and-go traffic or a fuel-efficiency impacting weather event like high winds); etc.

The systems and methods disclosed herein may be implemented with any of a number of different vehicles and vehicle types. For example, the systems and methods disclosed herein may be used with automobiles, trucks, motorcycles, recreational vehicles and other like on- or off-road vehicles. In addition, the principals disclosed herein may also extend to other vehicle types as well (e.g., electric vehicles, hybrid vehicles, gasoline and diesel powered vehicles, etc.).

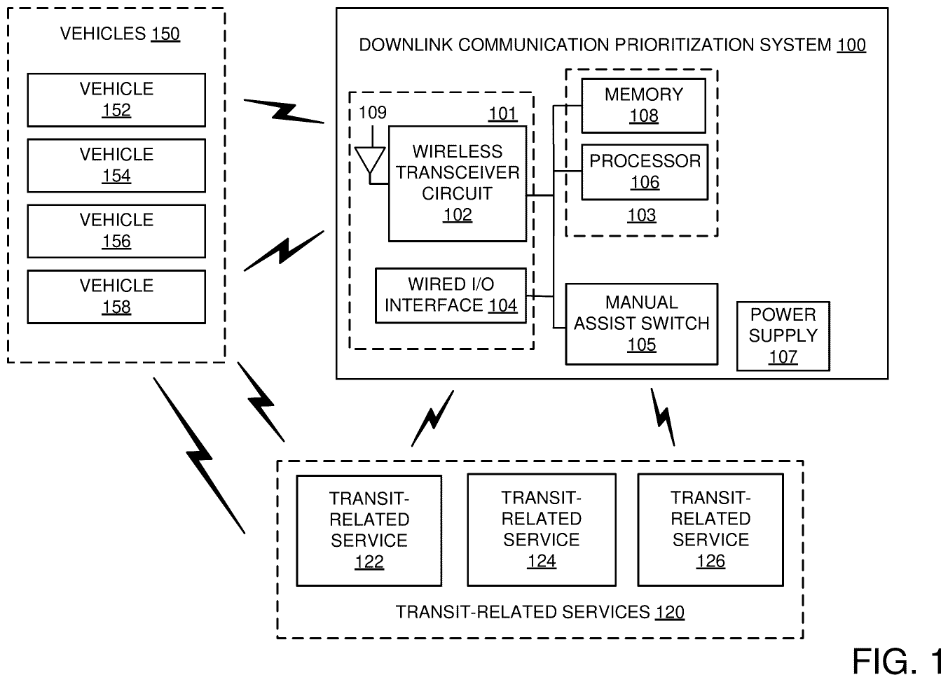

FIG. 1 illustrates an example downlink communication prioritization system 100, in accordance with various examples of the present technology. Referring now to FIG. 1, in this example, downlink communication prioritization system 100 may communicate with a plurality of vehicles 150 and a plurality of transit-related services 120. Downlink communication prioritization system 100 can communicate with vehicles 150 and transit-related services 120 via a wired or wireless communication interface.

In various examples, downlink communication prioritization system 100 can be implemented as a cloud-based service. In other examples, downlink communication prioritization system 100 may be implemented differently. For example, downlink communication prioritization system 100 can be implemented in a piece of roadside infrastructure, in an electronic control unit (ECU) of a vehicle, etc.

Downlink communication prioritization system 100 in this example includes a communication circuit 101, a decision circuit 103 (including a processor 106 and memory 108 in this example) and a power supply 107. Components of downlink communication prioritization system 100 are illustrated as communicating with each other via a data bus, although other communication in interfaces can be included. Downlink communication prioritization system 100 in this example also includes a manual assist switch 105 that can be operated by a user to manually select the downlink communication prioritization mode.

Processor 106 can include a GPU, CPU, microprocessor, or any other suitable processing system. The memory 108 may include one or more various forms of memory or data storage (e.g., flash, RAM, etc.) that may be used to store the calibration parameters, images (analysis or historic), point parameters, instructions and variables for processor 106 as well as any other suitable information. For example, memory 108 may be used to store transit-impacting event category-specific parameters that processor 106 uses to compute downlink communication priority scores. Memory 108, can be made up of one or more modules of one or more different types of memory, and may be configured to store data and other information as well as operational instructions that may be used by the processor 106.

Although the example of FIG. 1 is illustrated using processor and memory circuitry, as described below with reference to circuits disclosed herein, decision circuit 103 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a downlink communication prioritization system 100.

Communication circuit 101 may include either or both of a wireless transceiver circuit 102 with an associated antenna 109 and a wired I/O interface 104 with an associated hardwired data port (not illustrated). As this example illustrates, communications with downlink communication prioritization system 100 can include either or both wired and wireless communications. Wireless transceiver circuit 102 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 109 is coupled to wireless transceiver circuit 102 and can be used by wireless transceiver circuit 102 to transmit radio signals wirelessly and to receive radio signals as well.

Wired I/O interface 104 can include a transmitter and a receiver (not shown) for hardwired communications with other devices. Wired I/O interface 104 can communicate with other devices using Ethernet or any of a number of other wired communication protocols whether standardized, proprietary, open, point-to-point, networked or otherwise.

Power supply 107 can include one or more of a battery or batteries (such as, e.g., Li-ion, Li-Polymer, NiMH, NiCd, NiZn, and NiH₂, to name a few, whether rechargeable or primary batteries), a power connector (e.g., to connect to vehicle supplied power, etc.), an energy harvester (e.g., solar cells, piezoelectric system, etc.), or it can include any other suitable power supply.

Vehicles 150 can include any number of connected vehicles (e.g., vehicle 152, vehicle 154, vehicle 156, vehicle 158, and so). As alluded to above, downlink communication prioritization system 100 can receive information from, or send information to, vehicles 150 (individually or in combination) via wireless communication. For example, downlink communication prioritization system 100 can receive information related to geographical locations, characteristics (e.g., make and model of vehicle, enabled safety features, etc.) and operating conditions (e.g., speed, heading, navigation route, etc.) of vehicles 150, from vehicles 150. In certain examples, downlink communication prioritization system 100 can also receive information related to transit-impacting events (e.g., traffic jams, accidents, unsafe road conditions, etc.) from vehicles 150. As alluded to above, in some examples downlink communication prioritization system 100 can also transmit downlink communications related to a transit-impacting event to vehicles 150 according to a determined downlink communication priority order.

Transit-related services 120 can include any number of transit-related services (e.g., transit-related service 122, transit-related service 124, transit-related service 126, and so). Transit-related services 120 may be various types of transit-related services (e.g., traffic jam-detection services, accident detection services, unsafe road condition detection services, vehicle navigation services, weather reporting services, vehicle software update services, etc.) that provide information to the connected vehicles (e.g., vehicles 150) via downlink communication.

As alluded to above, downlink communication prioritization system 100 can receive information from, or send information to, transit-related services 120 (individually or in combination) via wireless communication. For example, downlink communication prioritization system 100 can receive information related to transit-impacting events and vehicles 150 from transit-related services 120. As alluded to above, downlink communication prioritization system 100 can also receive, from transit-related services 120, requests to provide downlink communication priority order(s) for transmitting downlink communications related to transit-impacting event(s). Upon determining the requested downlink communication priority order(s), downlink communication prioritization system 100 can then transmit the requested/determined downlink communication priority order(s) to transit-related services 120. Accordingly, transit-related services 120 can transmit downlink communications to vehicles 150 according to the determined downlink communication priority order(s).

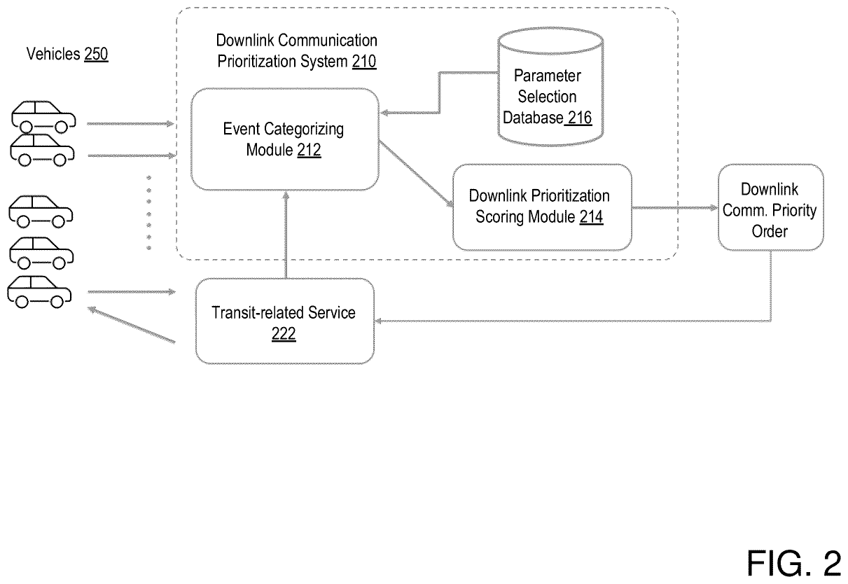

FIG. 2 illustrates an example downlink communication prioritization system 210, in accordance with various examples of the present technology.

Downlink communication prioritization system 210 includes an event categorizing module 212, a downlink prioritization scoring module 214 and a parameter selection database 216.

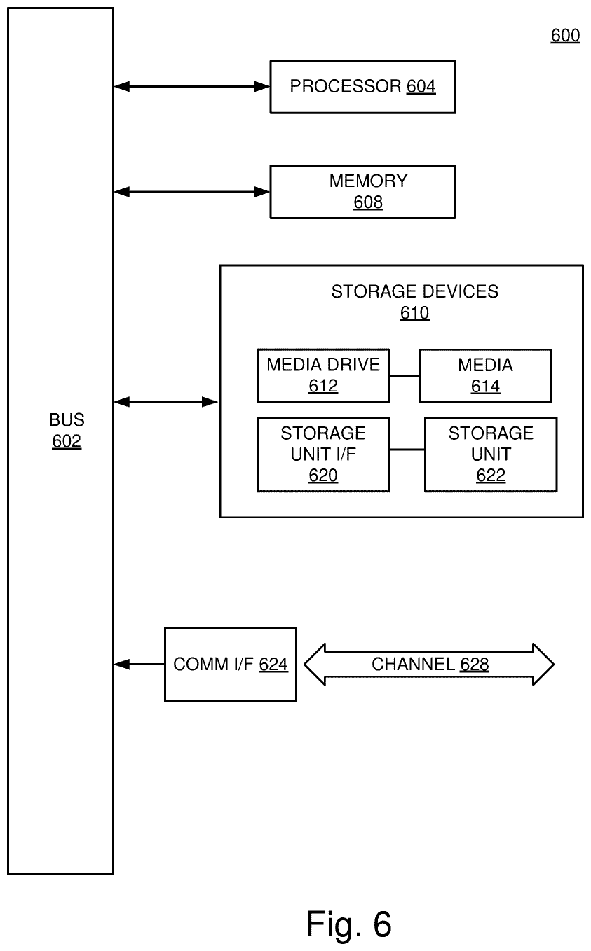

In various examples, downlink communication prioritization system 210 (and its constituent modules and database) can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some instances, downlink communication prioritization system 210 (and its constituent modules) can be, in part or in whole, implemented as software running on one or more computing devices or systems, such as on a server system, a cloud-computing system, or more generally a computing system such as the computing systems described in conjunction with FIGS. 1 and 6. In some examples, downlink communication prioritization system 210 can be implemented as or within a dedicated application (e.g., app), a program, etc., running on such a computing system.

Referring again to FIG. 2, downlink communication prioritization system 210 is in wireless communication with a plurality of vehicles 250 and a transit-related service 222. Like vehicles 150, vehicles 250 may comprise any number of connected vehicles. Like transit-related services 120, transit-related service 222 may be various types of transit-related services (e.g., traffic jam-detection services, accident detection services, unsafe road condition detection services, vehicle navigation services, weather reporting services, vehicle software update services, etc.) that provide information to vehicles 250 via downlink communication.

Downlink communication prioritization system 210 may receive, from transit-related service 222, a request to provide a downlink communication priority order for transmitting downlink communications related to a transit-impacting event. The transit-impacting event may be various types of events that impact vehicular transit (e.g., a traffic jam, a road closure, an accident, an unsafe road condition, a weather event, etc.). As alluded to above, and as will be described below, the downlink communication priority order may comprise a recommended order (e.g., an ordered list of vehicles 250) for transmitting downlink communications related to the transit-impacting event.

Event Categorizing Module 212: Upon receiving the downlink communication priority order request from transit-related service 222, downlink communication prioritization system 210 can determine a transit-impacting event category for the transit-impacting event using event categorizing module 212. Event categorizing module 212 can make this determination based on characteristics of the transit-impacting event (such information may be included with the downlink communication priority order request) as well as characteristics (and/or identity) of transit-related service 222. Event categorizing module 212 can use various techniques to make this categorization/determination including machine learning (ML) and artificial intelligence (AI)-based techniques. In some instances, transit-related service 222 may specify a transit-impacting event category in its downlink communication priority order request.

As alluded to above, by categorizing a wide variety of transit-impacting events into common/more general transit-impacting event categories, downlink communication prioritization system 210 can make tailored downlink priority order recommendations in a computationally efficient manner. Downlink communication prioritization system 210 achieves this by leveraging transit-impacting event category-specific parameters for computing downlink communication priority scores for vehicles. That is, instead of using a “one-size-fits-all” set of parameters for all types of transit-impacting events, downlink communication prioritization system 210 can leverage transit-impacting event category-specific parameters to determine downlink communication priority orders for particular transit-impacting events with greater accuracy/granularity. Conversely, instead of using unique/specific sets of parameters for each of the myriad transit-impacting events that may occur, downlink communication prioritization system 210 can determine/classify similar transit-impacting events using a common transit-impacting event category. Accordingly, downlink communication prioritization system 210 can determine downlink communication priority orders more efficiently/quickly by leveraging transit-impacting event category-specific parameters for the common (and more generic) transit-impacting event category. Moreover, downlink communication prioritization system 210 can tune the above-described balance/trade-off between accuracy/granularity and computational efficiency/speed by tuning a level of granularity for the transit-impacting event categories. In particular, increasing granularity for transit-impacting event categories (e.g., an unsafe road condition event category instead of a traffic safety-impacting event category, or an icy road condition event category instead of an unsafe road condition event category) may improve accuracy/granularity for downlink communication priority orders at a cost of reduced computational efficiency/speed. By contrast, decreasing granularity for transit-impacting event categories may improve computational efficiency/speed at a cost of improved accuracy/granularity. Either way, by leveraging transit-impacting event categories and transit-impacting event category-specific parameters, downlink communication prioritization system 210 can tune improving accuracy/granularity vs. improving computational efficiency/speed in a highly configurable manner.

As depicted, the above-described transit-impacting event category parameters may be stored in a parameter selection database 216. Parameter selection database 216 can be configured to store and maintain parameters specific to various transit-impacting event categories and various other types of data. Accordingly, once event categorization module 212 has determined a transit-impacting event category for the transit-impacting event, downlink communication prioritization system 210 can retrieve parameters specific to the (determined) transit-impacting event category for computing downlink prioritization scores. In various examples, the parameters specific to the (determined) transit-impacting event category may have transit-impacting event category-specific weights as well. That is, two different transit-impacting event categories may have the same/similar associated parameters, but those parameters may be weighted differently.

As alluded to above, parameters (and/or associated parameter weights) for computing downlink prioritization scores can differ by transit-impacting event category. As a simple example to illustrate the concept, a first transit-impacting event category may comprise an unsafe road condition event category and a second transit-impacting event category may comprise a traffic jam event category. A parameter related to enabled safety features for a vehicle may be a parameter used for computing downlink prioritization scores for the unsafe road condition event category that is not used (or weighted less heavily) for computing downlink prioritization scores for the traffic jam event category. By contrast, a parameter related to a level of travel urgency for a vehicle (e.g., an emergency vehicle traveling to an emergency may have a higher level of travel urgency than a standard commuter vehicle) may be a parameter used for computing downlink prioritization scores for the traffic jam event category that is not used (or weighted less heavily) for computing downlink prioritization scores for the unsafe road condition event category. As another example, navigation route may be a highly-weighted parameter for a location-specific transit-impacting event category such as an accident event category or a road closure event category while being a lower-weighted parameter for a less location-specific transit-impacting event category such as a weather event category (i.e., snow or high winds may impact a larger geographical area such that specific navigation route is less important than e.g., the types of safety features equipped on a vehicle).

Downlink Prioritization Module 214: After event categorizing module 212 has determined a category for the transit-impacting event, downlink prioritization module 214 can use the set of parameters specific to the transit-impacting event category to compute downlink communication priority scores for vehicles 250.

As used herein, a downlink communication priority score may refer to a measurement assigned to a given vehicle that quantifies a level of urgency for transmitting a downlink communication related to the transit-impacting event to the given vehicle. Computing a downlink communication priority for the given vehicle may involve applying, to the transit-impacting event category-specific parameters: (a) geographical locations associated with the transit-impacting event and the given vehicle and; (b) specific characteristics of the transit-impacting event and/or the given vehicle. Such information may be obtained from vehicles 250 themselves, transit-related service 222, roadside infrastructure, a combination of the foregoing, etc.

As alluded to above, downlink prioritization module 214 can leverage the transit-impacting event category-specific parameters to compute tailored downlink communication priority scores. That is, instead of using a “one-size-fits-all” set of parameters for all types of transit-impacting events, downlink prioritization module 214 can leverage transit-impacting event category-specific parameters to determine downlink communication priority orders for particular transit-impacting events with greater accuracy/granularity.

In certain examples, the set of parameters used to compute the downlink communication priority scores may also be specific to transit-related service 222. Accordingly, downlink communication prioritization system 210 may include a transit-related service categorizing module (not depicted) that determines a transit-related service category for transit-related service 222. Accordingly, the set of parameters used to compute the downlink communication priority scores may also be specific to the (determined) transit-related service category.

As depicted, upon computing the downlink communication priority scores for vehicles 250, downlink communication prioritization system 210 can transmit the determined downlink communication priority order to transit-related service 222. As alluded to above, the transmitted/determined downlink communication priority order may comprise a recommended order (e.g., an ordered list of vehicles 250) for transmitting downlink communications related to the transit-impacting event. In certain examples, instead of transmitting the determined downlink communication priority order to transit-related service 222, downlink communication prioritization system 210 can transmit downlink communications related to the transit-impacting event directly to vehicles 250 according to the determined downlink communication priority order.

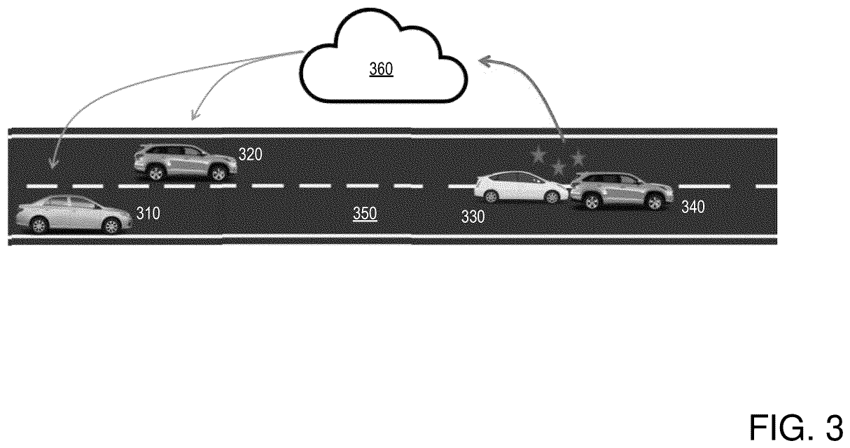

FIG. 3 depicts an example transit-impacting event during which various examples of the present technology may be implemented.

In particular, FIG. 3 depicts an example accident event caused by vehicle 330 colliding with vehicle 340. The accident occurs on a road segment 350.

As depicted vehicles 310 and 320 are approaching the location of the accident.

In the specific example of FIG. 3, a transit-related service (e.g., an accident detection/alerting service, a traffic safety service, etc.) may detect the accident between vehicles 330 and 340. The transit-related service may thus want to alert all (connected) vehicles (such as vehicles 310 and 320) approaching the location of the accident. Accordingly, the transit-related service may request a downlink communication priority order from downlink communication prioritization system 360. That is, the transit-related service may request assistance for determining which connected vehicles to alert first—namely those connected vehicles that would benefit the most from receiving earlier alerts.

As described above, upon receiving the request for the downlink communication priority order, downlink communication prioritization system 360 may first determine a transit-impacting event category for the accident event. Depending on a configured level of granularity for transit-impacting event categories, such a transit-impacting event category may comprise a traffic safety-impacting event, an accident event, etc.

As described above, upon determining a transit-impacting event category for the accident event, downlink communication prioritization system 360 can compute downlink communication priority scores for vehicles 310 and 320 (as well as other connected vehicles) using parameters that are specific to the (determined) transit-impacting event category. If for example the (determined) transit-impacting event category is a traffic-safety impacting event category, the parameters specific to the traffic-safety impacting event category may comprise e.g., distance between a vehicle and the traffic-safety impacting event, vehicle speed, vehicle heading (e.g., is a vehicle heading/navigating towards a geographic location of a traffic-impacting event), vehicle type (e.g., vehicle make and model, vehicle age, whether the vehicle is a high-occupancy vehicle), vehicle capabilities (e.g., enabled safety features for a vehicle such as assisted driving features/collision detection), etc. Accordingly, by applying, to the traffic-safety impacting event category-specific parameters: (a) characteristics of the accident event (e.g., geographical location of the accident event); (b) geographical location of the vehicles (e.g., geographical locations of the vehicles 310 and 320); and (c) characteristics of the vehicles (e.g., speed, heading, vehicle type, vehicle capabilities, etc. of vehicles 310 and 320)—downlink communication prioritization system 360 can compute downlink communication priority scores for vehicles 310 and 320 (as well as other connected vehicles).

Based on the foregoing, downlink communication prioritization system 360 may determine that vehicle 310 should be alerted to the accident event first because vehicle 310 is an older vehicle model with an inferior ability to avoid the accident (e.g., because it has fewer advanced safety features, inferior braking systems, etc.). Accordingly, downlink communication prioritization system 360 can transmit a downlink communication priority order to the requesting transit-related service indicating that vehicle 310 should be alerted before vehicle 320. Alternatively, in certain examples downlink communication prioritization system 360 can transmit downlink communications directly to vehicles 310 and 320 according to the determined downlink communication priority order.

It should be understood that FIG. 3 is merely an illustrative example with two connected vehicles. In other scenarios, the scale of connected vehicles for which downlink communication priority is determined may be orders of magnitude larger (e.g., hundreds of vehicles, thousands of vehicles, tens of thousands of vehicle, etc.). Accordingly a determination regarding which connected vehicles (of e.g., tens of thousands of connected vehicles) are alerted first to a transit-impacting event can be quite impactful. Namely, by providing systems and methods for prioritizing downlink vehicle communication, the present technology can: (1) improve traffic safety (by e.g., accurately determining which vehicles should be alerted first to a given traffic safety-impacting event such as an unsafe road condition); (2) increase driver and passenger comfort (by e.g., accurately determining which vehicles should be alerted first to a given traffic efficiency-impacting event such as traffic jam or road closure); (3) improve fuel efficiency (by e.g., accurately determining which vehicles should be alerted first to a given fuel efficiency-impacting event such as stop-and-go traffic or a fuel-efficiency impacting weather event like high winds); etc.

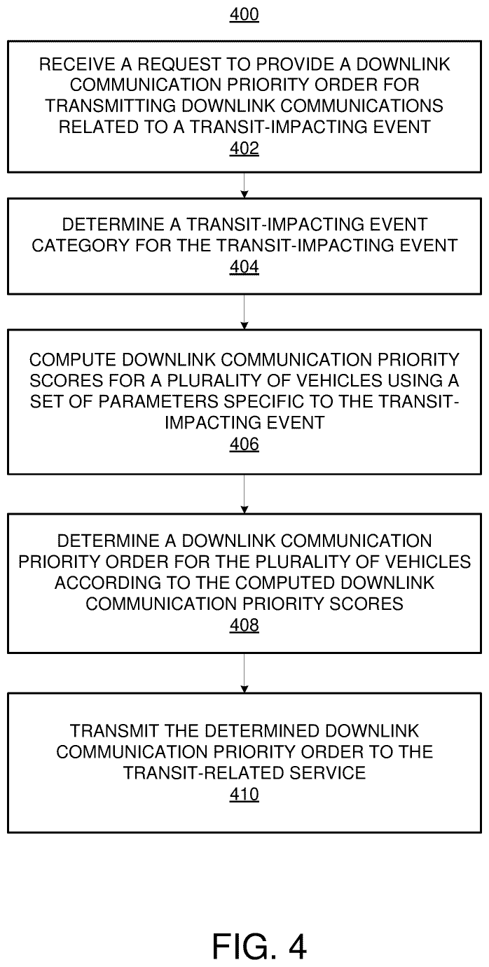

FIG. 4 illustrates example operations 400 that can be performed by a downlink communication prioritization system to determine a downlink communication priority order for a plurality of vehicles, in accordance with various examples of the present technology. In certain examples, these operations may be performed by downlink communication prioritization system 110 and/or downlink communication prioritization system 210. In certain examples the downlink communication prioritization system may be a cloud-based system. In other examples the downlink communication prioritization system may be implemented differently. For example, downlink communication prioritization system can be implemented in a vehicle ECU, a piece of roadside infrastructure, etc.

At operation 402, the downlink communication prioritization system receives, from a transit-related service, a request to provide a downlink communication priority order for transmitting downlink communications related to a transit-impacting event. This operation may be performed in the same/similar manner as described above in conjunction with FIGS. 1-3.

For example, the transit-related service may comprise a service (e.g., a cloud-based service) that provides information to vehicles via downlink communication.

In certain examples, downlink communication prioritization system may receive additional information from the transit-related service (e.g., further information related to the transit-impacting event such as geographical location associated with the transit-impacting event, characteristics of the transit-impacting event, geographical locations and characteristics of vehicles the transit-related service wants to transmit downlink communications to, etc.).

At operation 404, the downlink communication prioritization system determines a transit-impacting event category for the transit-impacting event. This operation may be performed in the same/similar manner as described above in conjunction with FIGS. 1-3.

For example, the downlink communication prioritization system can determine the transit-impacting event category for the transit-impacting event based on characteristics of the transit-impacting event (as alluded to above, such information may be included with the downlink communication priority order request) as well as characteristics (and/or identity) of the transit-related service making the request. The downlink communication prioritization system can use various techniques to make this categorization/determination including machine learning (ML) and artificial intelligence (AI)-based techniques. In some instances, the transit-related service may specify a transit-impacting event category in its downlink communication priority order request.

Non-limiting examples of transit-impacting event categories can include: a traffic safety-impacting event category; a traffic efficiency-impacting event category; a fuel-efficiency impacting-event category; a road closure event category; a traffic jam event category; a vehicle accident event category; an unsafe road condition event category; a weather-related event category; etc.

At operation 406, the downlink communication prioritization system computes downlink communication priority scores for a plurality of vehicles using a set of parameters specific to the (determined) transit-impacting event category. This operation may be performed in the same/similar manner as described above in conjunction with FIGS. 1-3.

For example, a downlink communication priority score may comprise a measurement assigned to a vehicle of the plurality of vehicles that quantifies a level of urgency for transmitting downlink communication related to the transit-impacting event to the vehicle.

In certain examples, using the set of parameters specific to the transit-impacting event category to compute the downlink communication priority scores for the plurality of vehicles may comprise applying, to the set of parameters specific to the transit-impacting event category, geographical locations of the plurality of vehicles and characteristics of the plurality of vehicles. In these examples, a geographical location associated with the transit-impacting event may also be applied to the set of parameters specific to the transit-impacting event category.

In some examples, the set of parameters specific to the transit-impacting event category may have weights that are also specific to the transit-impacting event category.

In certain examples, the set of parameters specific to the transit-impacting event category may also be specific to a transit-related service category. Accordingly, in these examples, the downlink communication prioritization system may determine a transit-related service category for the transit-related service. In related examples, the set of parameters specific to the transit-impacting event category may also be specific to the transit-related service (i.e., the transit-related service itself as opposed to a category).

In specific examples where the transit-impacting event category comprises an unsafe road collision category the set of parameters specific to the unsafe road condition category may comprise at least one of: type of unsafe road condition; vehicle distance to a geographical location of an unsafe road condition; vehicle navigation route; vehicle type; and vehicle capabilities. In specific examples where the determined transit-impacting event category comprises a traffic jam event category the set of parameters specific to the traffic jam event category may comprise at least one of: vehicle distance to a geographical location of a traffic jam; vehicle navigation route; a vehicle type (e.g., emergency vehicle or commercial vehicle); and level of travel urgency (e.g., a high level of travel urgency for an emergency vehicle responding to an emergency and a relatively lower level of urgency for a commuter vehicle).

At operation 408, the downlink communication prioritization system can transmit the (determined) downlink communication priority order to the transit-related service. This operation may be performed in the same/similar manner as described above in conjunction with FIGS. 1-3.

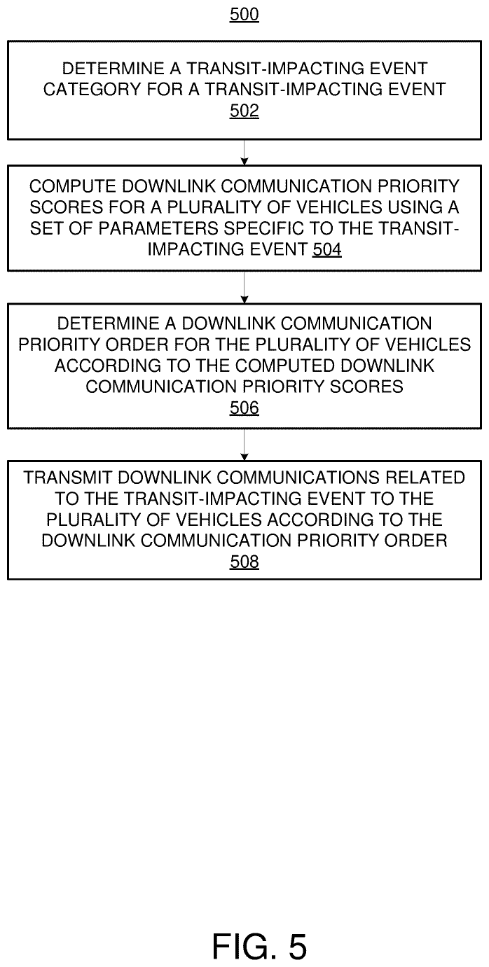

FIG. 5 illustrates example operations 500 that can be performed by a downlink communication prioritization system to determine a downlink communication priority order for a plurality of vehicles, in accordance with various examples of the present technology. In certain examples, these operations may be performed by downlink communication prioritization system 110 and/or downlink communication prioritization system 210. In certain examples the downlink communication prioritization system may be a cloud-based system. In other examples the downlink communication prioritization system may be implemented differently. For example, downlink communication prioritization system can be implemented in a vehicle ECU, a piece of roadside infrastructure, etc.

At operation 502, the downlink communication prioritization system determines a transit-impacting event category for a transit-impacting event. In some cases this determination may be made in response to a request from a transit-related service, although this need not be the case. For example, in certain examples the downlink communication prioritization system may be implemented as part of a transit-related service.

Here operation 502 may be performed in the same/similar manner as described in conjunction with operation 404 of FIG. 4.

At operation 504, the downlink communication prioritization system computes downlink communication priority scores for a plurality of vehicles using a set of parameters specific to the (determined) transit-impacting event category. Operation 504 may be performed in the same/similar manner as described in conjunction with operation 406 of FIG. 4.

At operation 506, the downlink communication prioritization system determines a downlink communication priority order for the plurality of vehicles according to the downlink communication priority scores. In various examples, this may comprise ranking/ordering the plurality of vehicles according to their respective downlink communication priority scores (e.g., where vehicles having increasing downlink communication priority scores are ranked higher).

At operation 508, the downlink communication prioritization system transmits downlink communications related to the transit-impacting event to the plurality of vehicles, according to the (determined) downlink communication priority order. The downlink communication prioritization system may perform this operation in the same/similar manner as described in conjunction with FIGS. 1-3.

As used herein, the terms circuit and component might describe a given unit of functionality that can be performed in accordance with one or more examples of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various examples are described in terms of this example-computing component 600. After reading this description, it will become apparent to a person skilled in the relevant art how to implement the application using other computing components or architectures.

Referring now to FIG. 6, computing component 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. Processor 604 might be implemented using a general-purpose or special-purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory, might be used for storing information and instructions to be executed by processor 604. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative examples, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

It should be understood that the various features, aspects and functionality described in one or more of the individual examples are not limited in their applicability to the particular example with which they are described. Instead, they can be applied, alone or in various combinations, to one or more other examples, whether or not such examples are described and whether or not such features are presented as being a part of a described example. Thus, the breadth and scope of the present application should not be limited by any of the above-described exemplary examples.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various examples set forth herein are described in terms of exemplary block diagrams, flow charts and other illustrations. As will become apparent to one of ordinary skill in the art after reading this document, the illustrated examples and their various alternatives can be implemented without confinement to the illustrated examples. For example, block diagrams and their accompanying description should not be construed as mandating a particular architecture or configuration.

What is claimed is:

1. A computer-implemented method comprising:
determining a transit-impacting event category for a transit-impacting event;
computing downlink communication priority scores for a plurality of vehicles using a set of parameters specific to the transit-impacting event category;
determining a downlink communication priority order for the plurality of vehicles according to the downlink communication priority scores; and
transmitting the downlink communication priority order to a transit-related service.

2. The computer-implemented method of claim 1, wherein computing the downlink communication priority scores for the plurality of vehicles using the set of parameters specific to the transit-impacting event category comprises:
applying, to the set of parameters specific to the transit-impacting event category, geographical locations of the plurality of vehicles and characteristics of the plurality of vehicles.

3. The computer-implemented method of claim 2, further comprising:
applying a geographical location associated with the transit-impacting event to the set of parameters specific to the transit-impacting event category.

4. The computer-implemented method of claim 1, further comprising:
receiving, from the transit-related service, a request to provide the downlink communication priority order for transmitting downlink communications related to the transit-impacting event;
determining a transit-related service category for the transit-related service;
wherein the set of parameters specific to the transit-impacting event category are also specific to the transit-related service category.

5. The computer-implemented method of claim 1, wherein the set of parameters specific to the transit-impacting event category are also specific to the transit-related service.

6. The computer-implemented method of claim 1, wherein a downlink communication priority score comprises a measurement assigned to a vehicle of the plurality of vehicles that quantifies a level of urgency for transmitting downlink communication related to the transit-impacting event to the vehicle.

7. The computer-implemented method of claim 1, wherein the transit-related service comprises a cloud-based service that provides information to vehicles via downlink communication.

8. The computer-implemented method of claim 1, wherein the set of parameters specific to the transit-impacting event category have weights that are also specific to the transit-impacting event category.

9. The computer-implemented method of claim 1, wherein the transit-impacting event category comprises at least one of:
a road closure event category;
a traffic jam event category;
a vehicle accident event category;
an unsafe road condition event category; and
a weather-related event category.

10. The computer-implemented method of claim 9, wherein the determined transit-impacting event category comprises an unsafe road collision category and the set of parameters specific to the unsafe road condition category comprise at least one of:
type of unsafe road condition;
vehicle distance to a geographical location of an unsafe road condition;
vehicle navigation route;
vehicle type; and
vehicle capabilities.

11. A system comprising:
one or more processing resources; and
a non-transitory computer-readable medium, coupled to the one or more processing resources, having stored therein instructions that when executed by the one or more processing resources cause the system to perform a method comprising:
determining a transit-impacting event category for a transit-impacting event;
computing downlink communication priority scores for a plurality of vehicles using a set of parameters specific to the transit-impacting event category;
determining a downlink communication priority order for the plurality of vehicles according to the downlink communication priority scores; and
transmitting, according to the downlink communication priority order, downlink communications related to the transit-impacting event to the plurality of vehicles.

12. The system of claim 11, wherein the system comprises a cloud-based system.

13. The system of claim 11, wherein the system is implemented in roadside infrastructure.

14. The system of claim 11, wherein the method further comprises:
receiving, from a transit-related service, information associated with the transit-impacting event.

15. The system of claim 14, wherein the transit-related service is a cloud-based service.

16. The system of claim 11, wherein the transit-impacting event category comprises at least one of:
a road closure event category;
a traffic jam event category;
a vehicle accident event category;
an unsafe road condition event category; and
a weather-related event category.

17. The system of claim 16, wherein the determined transit-impacting event category comprises a traffic jam event category and the set of parameters specific to the traffic jam event category comprise at least one of:
vehicle distance to a geographical location of a traffic jam;
vehicle navigation route;
vehicle type; and
level of travel urgency.

18. A cloud-based system comprising:
one or more processing resources; and
a non-transitory computer-readable medium, coupled to the one or more processing resources, having stored therein instructions that when executed by the one or more processing resources cause the device to perform a method comprising:
determining a transit-impacting event category for a transit-impacting event;
computing downlink communication priority scores for a plurality of vehicles by applying geographic locations associated with the plurality of vehicles and characteristics associated with the plurality of vehicles to a set of parameters specific to the transit-impacting event category;
determining a downlink communication priority order for the plurality of vehicles according to the downlink communication priority scores; and
transmitting the downlink communication priority order to a transit-related service.

19. The cloud-based system of claim 18, wherein the method further comprises:
receiving, from the transit-related service, a request to provide the downlink communication priority order for transmitting downlink communications related to the transit-impacting event;
determining a transit-related service category for the transit-related service;
wherein the set of parameters specific to the transit-impacting event category are also specific to the transit-related service category.

20. The cloud-based system of claim 19, wherein the set of parameters specific to the transit-impacting event category are also specific to the transit-related service.
